(19) United States
(12) Patent Application Publication
(10) Pub. No.: US 2026/0285086 A1
(43) Pub. Date: Sep. 24, 2026

(54) WHEEL BEARING ASSEMBLY

(71) Applicant: VOLKSWAGEN AKTIENGESELLSCHAFT, Wolfsburg (DE)

(72) Inventor: Gregor Schaaf, Cremlingen (DE)

(21) Appl. No.: 19/476,654

(22) PCT Filed: Mar. 15, 2024
(86) PCT No.: PCT/EP2024/057018

§ 371 Date: Oct. 17, 2025

(30) Foreign Application Priority Data
Apr. 21, 2023 (DE) 10 2023 203 703.3

(51) Int. Cl. B60B 27/00; F16C 33/78; F16C 33/80

(52) U.S. Cl. CPC B60B 27/0073; B60B 27/0031; F16C 33/782; F16C 33/7886; F16C 33/805; F16C 2326/02

(57) ABSTRACT

Aspects of the present disclosure relate to a wheel bearing assembly including a wheel hub, a wheel bearing arranged on the wheel hub, and a wheel carrier to which the wheel bearing is fixed by way of a wheel-bearing outer ring. A constant-velocity joint is axially clamped to the wheel hub through a face-serration-type coupling assembly for torque transmission. A sealing ring radially surrounds and seals the face-serration-type coupling assembly. The sealing ring is pre-assembled on the constant-velocity joint and, in the assembled state of the wheel-bearing assembly, engages the wheel hub outside the power flow of the wheel bearing. In cooperation with the wheel carrier, the sealing ring simultaneously provides a non-contact pre-seal for the wheel bearing to inhibit the ingress of water and contaminants while allowing low-friction operation.

### RELATED APPLICATIONS

The present application claims priority to International Patent Application No. PCT/EP2024/057018 to Gregor Schaaf, filed Mar. 15, 2024, which claims priority from German Patent App. No. DE 10 2023 203 703.3, filed Apr. 21, 2023, the contents of each being incorporated by reference in their entirety herein.

### TECHNICAL FIELD

Aspects of the present disclosure relate to a wheel bearing assembly comprising a wheel hub, a wheel bearing, which is arranged at the wheel hub, a wheel carrier, to which the wheel bearing is fixed with a wheel bearing outer ring, a constant velocity joint, which is axially clamped to the wheel hub by way of a face serration assembly, and a sealing ring, which surrounds the face serration assembly radially on the outside and seals the same.

### BACKGROUND

Axially clamped face serration assemblies are increasingly being used in wheel bearing assemblies of driven wheel axles, serving as a connection for the backlash-free torque transmission between a drive shaft and a wheel hub. In particular when transmitting high torques, such as in particular in motor vehicles comprising an electric drive, the use of such axially clamped face serration assemblies, which sometimes are also referred to as Hirth joints or face gear systems, has advantages over conventional spline systems since the transmission of torque can even be ensured well at high changing torques without relative movements, which can result from the torsional elasticity of splines, and without disturbing noise (ping noise).

So as to the ensure the torque transmission function, the face serration assembly must be clamped using a high axial force. The two face serrations that are consequently subject to high material stresses and meshed with one another must be appropriately protected against corrosion.

A wheel bearing assembly of the type in question is known from DE 10 2015 211 455 B4. In particular, DE 10 2015 211 455 B4 proposes a spacer element which is arranged between the wheel bearing and the drive shaft. This spacer element comprises a contact web, which radially seals the face serration assembly in the assembled state, as well as a sealing section extending in the radial direction, which cooperates with an outer ring of the wheel bearing serving as a pre-seal for the same. During assembly, the spacer element and the rolling bearing inner rings of the wheel bearing are pushed together axially and are clamped axially between the wheel hub and the drive shaft. In other words, axial forces of the wheel bearing are supported by way of the spacer element, which must therefore be reinforced accordingly. The sealing function comes at an accordingly high price.

Further sealing concepts for wheel bearing assemblies having torque transmission by means of a face serration assembly are known from WO 2010/018041 A1 and WO 2006/111146 A2.

### SUMMARY

Aspects of the present disclosure are directed to alternative sealing concepts for a wheel bearing assembly of the type described above.

In some examples, a wheel bearing assembly is disclosed, comprising a wheel hub; a wheel bearing arranged at the wheel hub; a wheel carrier, to which the wheel bearing is fixed with a wheel bearing outer ring; a constant velocity joint, which is axially clamped to the wheel hub (10) by way of a face serration assembly; and a sealing ring, which radially surrounds the face serration assembly on the outside and seals the same, characterized in that the sealing ring is pre-assembled on the constant velocity joint and, in the assembled state of the wheel bearing assembly, becomes engaged with the wheel hub outside the power flow of the wheel bearing, the sealing ring simultaneously providing a non-contact pre-seal for the wheel bearing in cooperation with the wheel carrier. The wheel bearing assembly may be configured such that the sealing ring is pre-assembled on the constant velocity joint and, in the assembled state of the wheel bearing assembly, becoming engaged with the wheel hub outside the power flow of the wheel bearing, whereby the sealing ring simultaneously provides a non-contact pre-seal for the wheel bearing in cooperation with the wheel carrier.

Compared to DE 10 2015 211 455 B4, the sealing ring in such configurations is no longer situated in the power flow of the transverse forces acting on the wheel bearing, but is supported, for example, against a front wall of the wheel hub. This allows the sealing ring to be manufactured much more cost-efficiently, for example also from plastic. The sealing ring thus assumes both a sealing function with respect to the face serration assembly to prevent the ingress of water and dirt, and the function of a non-contact pre-seal for the wheel bearing, so that water and dirt are prevented from penetrating to the actual wheel bearing seal. Due to the provision of the pre-seal, the actual wheel bearing seals can have a simpler design with less friction.

Other aspects of the present disclosure are described in the subject matter of the dependent claims.

In some examples, a wheel bearing assembly is disclosed, comprising: a wheel hub, a wheel bearing, which is arranged at the wheel hub, a wheel carrier, to which the wheel bearing is fixed with a wheel bearing outer ring, a constant velocity joint, which is axially clamped to the wheel hub by way of a face serration assembly, and a sealing ring, which radially surrounds the face serration assembly on the outside and seals the same. The wheel bearing assembly according to the invention is characterized in that the sealing ring comprises a sleeve-shaped first sealing section for radially sealing the face serration assembly and a sleeve-shaped second sealing section for providing a non-contact pre-seal for the wheel bearing, wherein the sleeve-shaped second sealing section is connected to the first sealing section by a radial web, and the wheel carrier has an annular groove, wherein a gap, acting as a sealing labyrinth, is formed between the sleeve-shaped first sealing section, the sleeve-shaped second sealing section, and the web on the one hand, and the annular groove at the wheel carrier on the other hand. Compared to DE 10 2015 211 455 B4, this enables a significant improvement, in particular in the sealing action of the pre-seal for the wheel bearing, at considerably lower cost. The improved pre-sealing action, in turn, enables the use of especially low-friction wheel bearing seals at the wheel bearing.

The sealing ring can in particular also be made of plastic material, resulting in greater freedom in terms of the shape, which in turn allows, for example, a more complex and thus more effective sealing gap to be provided than in DE 10 2015 211 455 B4.

### BRIEF DESCRIPTION OF THE DRAWINGS

Ways for carrying out aspects of the present disclosure will be described hereafter in greater detail based on exemplary embodiments illustrated in the drawings. In the drawings:

FIG. 1 shows a longitudinal sectional view of a wheel bearing assembly according to a first exemplary embodiment of the invention, according to some aspects of the present disclosure;

FIG. 2 shows a longitudinal sectional view of a wheel bearing assembly according to some aspects of the present disclosure;

FIG. 3 shows a longitudinal sectional view of a wheel bearing assembly according to another aspect of the present disclosure;

FIG. 4 shows a longitudinal sectional view of a wheel bearing assembly according to another aspect of the present disclosure;

FIG. 5 shows a longitudinal sectional view of a wheel bearing assembly according to another aspect of the present disclosure,

FIG. 6 shows a longitudinal sectional view of a wheel bearing assembly according to another aspect of the present disclosure;

FIG. 7 shows a schematic representation of a variant embodiment to illustrate a pre-assembly position (left) and a final assembly position (right) of components to be joined to one another, including an axially clamped face serration assembly, according to some aspects of the present disclosure;

FIG. 8 shows a longitudinal sectional view of a wheel bearing assembly according to another aspect of the present disclosure;

FIG. 9 shows a sectional view of a first variant embodiment of a sealing ring, another aspect of the present disclosure;

FIG. 10 shows a sectional view of a second variant embodiment of the sealing ring, according to some aspects of the present disclosure; and

FIG. 11 shows an exploded view of a wheel bearing assembly comprising a wheel carrier, a constant velocity joint, and a wheel hub including a wheel bearing, which can be connected to one another by way of an axially clamped face serration assembly, according to some aspects of the present disclosure.

### DETAILED DESCRIPTION

In some examples, the sealing ring comprises a sleeve-shaped first sealing section configured to radially seal the face serration assembly, and a sleeve-shaped second sealing section configured to provide the pre-seal. The sleeve-shaped second sealing section is connected to the first sealing section by a radial web. In this manner, a relatively complex labyrinth can be created, which effectively inhibits the passage of water and dirt.

In some aspects of the present disclosure, the radial web adjoins an axial end section of the sleeve-shaped first sealing section. The sleeve-shaped second sealing section and the web, together with a protrusion located at the wheel carrier, can form a sealing labyrinth, the course of which, from the outside to the inside of the pre-seal in a longitudinal section plane, includes at least two changes of direction. Such a configuration provides enhanced inhibition of water and dirt penetration and thereby reduces the risk of contamination reaching the actual wheel bearing seal.

In further aspects of the present disclosure, the sleeve-shaped first sealing section, the sleeve-shaped second sealing section, and the web can form a generally C-shaped longitudinal section profile in a longitudinal section plane. In this configuration, an annular groove is formed in which a corresponding longitudinal section profile of the wheel carrier engages. A gap acting as a sealing labyrinth is thus formed between the sleeve-shaped first sealing section, the sleeve-shaped second sealing section, and the web on one hand, and the corresponding longitudinal section profile of the wheel carrier on the other hand.

The corresponding longitudinal section profile at the wheel carrier can, in turn, include at least one annular groove corresponding to the profile of the sealing ring to create a long, multiply angled labyrinth path for sealing purposes.

In some examples, the sealing ring further comprises a sleeve-shaped third sealing section that projects axially from the second sealing section in the direction of the constant velocity joint and sealingly rests against a sealing element of the constant velocity joint. This configuration allows the constant velocity joint to be completely covered on the outside, thereby eliminating the need for additional surface treatment to ensure a rust-free appearance. The cover provided by the sealing ring and the sealing element of the constant velocity joint can thus extend continuously from the wheel bearing pre-seal to the opening of the constant velocity joint of an associated drive shaft on the side facing away from the wheel.

In a modification of the above configuration, the sealing ring comprises a sleeve-shaped third sealing section that projects axially from the second sealing section in the direction of the constant velocity joint and forms an annular gap with a sealing element of the constant velocity joint, allowing water that enters to be expelled by centrifugal force. The deliberately provided annular gap enables water to be forced outward as soon as the constant velocity joint rotates.

In some configurations, the annular gap has a minor gap width of approximately 1 to 3 mm, which maintains the covering function while permitting water removal. In many applications, this configuration is primarily directed to maintaining a rust-free external appearance.

The sealing element of the constant velocity joint may include, for example, a bellows, a rolling-lobe bellows, and/or a sheet-metal cap. This sealing element closes the constant velocity joint on its opening side so that no grease escapes and no dirt enters the constant velocity joint. Sheet-metal caps are typically pressed or crimped onto the outer diameter of the constant velocity joint, whereas bellows and rolling-lobe bellows can be secured to the outer diameter using hose clamps or similar fasteners.

In some examples, the third sealing section extends radially outward beyond the furthest radial outer extension of an annular groove that engages the sleeve-shaped second sealing section. This configuration provides an additional improvement in the pre-seal function.

In further aspects of the present disclosure, the spline-type face serration assembly comprises a first face serration at the wheel hub and a second face serration at the constant velocity joint, which are in toothing engagement with one another, together with a clamping device. In the clamped state, the clamping device axially clamps the first and second face serrations together. In the unclamped state of the clamping device, the sealing ring provides an assembly retainer that holds the first and second face serrations loosely in engagement such that the axial play is smaller than the height of the serration teeth. This configuration simplifies the assembly of the wheel bearing assembly by allowing the alignment of components to be performed separately from the clamping step. Tooth-to-tooth engagement is thereby prevented, while clamping can occur subsequently. All functions, namely sealing of the face serration assembly, pre-sealing of the wheel bearing, and the assembly assistance, are integrated into a single component in this example, which can be manufactured efficiently and cost-effectively.

In some examples, the sealing ring is fixed to one of the constant velocity joint or the wheel hub and is coupled to the other by a detent mechanism. This configuration allows the sealing ring to be pre-assembled on one of the components to be joined. For instance, the sealing ring can be firmly pressed onto, glued to, or otherwise attached to one of the two components, and during assembly, latchingly engages with the other component. In this manner, the components can be pre-fixed relative to one another before the actual clamping of the face serration assembly occurs.

In some examples, the wheel bearing assemblies described in more detail below each comprise a wheel hub 10, a wheel bearing 20, which is arranged at the wheel hub 10, a wheel carrier 30, to which the wheel bearing 20 is fixed with a wheel bearing outer ring 21, and a constant velocity joint 40 of a drive shaft, which is axially clamped to the wheel hub 10 by way of a face serration assembly 11/41, which will be described in more detail below, for torque transmission.

Furthermore, each of the wheel bearing assemblies comprises a sealing ring 50 that surrounds the face serration assembly radially on the outside and seals it. This sealing ring 50 is pre-assembled on the constant velocity joint 40 and, in the assembled state of the wheel bearing assembly, engages with the wheel hub 10 outside the power flow of the wheel bearing 20.

At the same time, this sealing ring 50, in cooperation with the wheel carrier 30, forms a non-contact pre-seal for the wheel bearing 20 to prevent water and dirt from penetrating the wheel bearing 20.

For example, the sealing ring 50 can have an end face 51 that, in the assembled state, is pressed against an opposing end wall 12 of the wheel hub 10.

Additional dedicated wheel bearing seals 24 and 25 are provided at the wheel bearing 20, specifically for sealing the rolling bearings 22 and 23 from the outside. These seals allow the rolling bearings 22 and 23 to mount the wheel bearing outer ring 21 so that it is rotatable with respect to the wheel hub 10. The aforementioned non-contact pre-seal provided by the sealing ring 50 is spaced apart from the rolling bearings 22 and 23 and is located between the constant velocity joint 40 and the wheel carrier 30. Thanks to the pre-sealing provided by the sealing ring 50, the dedicated wheel bearing seals 24 and 25 can have an especially low-friction design.

The rolling bearings 22 and 23 can be designed as complete bearings, each comprising a dedicated bearing inner ring, a dedicated bearing outer ring, and interposed rolling elements. However, it is also possible to integrate individual bearing rings into a shared wheel bearing outer ring 21 and/or into the wheel hub 10.

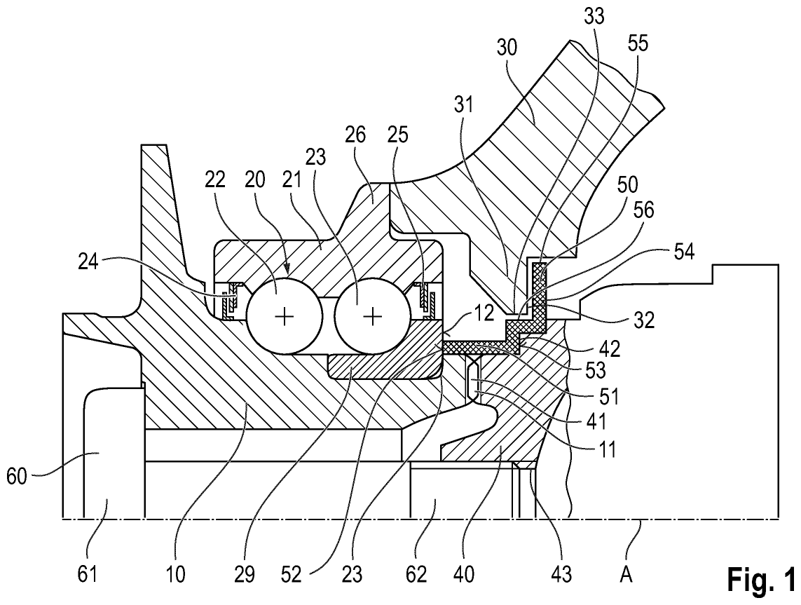

In FIG. 1, the bearing outer rings of the rolling bearings 22 and 23 are combined to form a shared wheel bearing outer ring 21, which also provides support and fastening structures 26 for the connection to the wheel carrier 30.

For the rolling bearing 22 on the left in FIG. 1, which lies furthest from the constant velocity joint, the bearing inner ring is integrated into the wheel hub 10. In contrast, the rolling bearing 23 on the right in FIG. 1, which is closer to the constant velocity joint, has the bearing inner ring 29 designed as a separate component. This bearing inner ring 29 may also be considered an integral part or subsection of the wheel hub 10. Depending on the design of the bearing inner rings, the aforementioned sealing ring 50 can also be supported on an end wall 12 of the bearing inner ring 29, which in this case functions as part of the wheel hub 10.

If separate bearing rings are present, they are axially fixed and supported on the respective wheel bearing outer ring 21 or the wheel hub 10 by suitable axial securing means, such as bearing shoulders, axial securing rings, receiving grooves, or the like. The bearing inner ring 29 can, for example, be fixed to the wheel hub 10 by a forming operation on an end section of the wheel hub 10, which can be accomplished through orbital forging or orbital pressing. The sealing ring 50 therefore does not need to absorb any axial bearing forces. Since this ring does not have a supporting function, there is greater design freedom for the sealing ring 50, allowing for more complex shapes. In particular, the sealing ring 50 can be made of plastic, which helps reduce costs.

Moreover, this enables integration into a wheel speed sensor, with the transmitter arranged as a ring in the wheel bearing seal 25. The associated pick-up can be positioned axially between the wheel bearing seal 25 and the sealing ring 50, while the corresponding sensor housing can accommodate additional components of the wheel speed sensor in a cut-out or borehole in the wheel carrier 30.

In addition to providing pre-sealing for the wheel bearing 20, the sealing ring 50 is also used to surround the aforementioned face serration assembly 11/41 radially on the outside and to seal the same, and thereby protect it against corrosion. For this purpose, the sealing ring 50 can, for example, be axially clamped between the wheel hub 10 and the constant velocity joint 40. However, it is also possible to fix the sealing ring 50 to the aforementioned components in another manner, for example by latching engagement, by pressing, by gluing or the like.

The face serration assembly 11/41 forms the interface between the constant velocity joint 40 and the wheel hub 10. For this purpose, a respective face serration 11 or 41 is formed on mutually opposing end walls of the constant velocity joint 40 and the wheel hub 10. The teeth of these two face serrations 11 and 41 mesh with one another. In the present example, a face serration is understood as an end-face radial serration structure on a component that can be coupled with a corresponding end-face radial serration structure on another component for the purpose of transmitting torque. The toothing engagement has zero backlash and is suitable for transmitting high torque. Such face serration assemblies are also occasionally referred to as Hirth joints or face gearing systems.

A clamping device 60, preferably in the form of a clamping bolt, is used in the clamped state to hold the two face serrations 11 and 41 in a meshed state with one another at the wheel hub 10 and the constant velocity joint 40.

The clamping device 60 preferably extends centrally through the two face serrations 11 and 41. In particular, the clamping device 60, or the clamping bolt, can be supported with a head 61 at the wheel hub 10 and bolted to the constant velocity joint 40 via thread 62. A reverse installation is also possible.

FIG. 1 shows a first exemplary embodiment in which the sealing ring 50 comprises a sleeve-shaped first sealing section 51 that radially surrounds the face serration assembly 11/41 like a sleeve and rests, for example, on corresponding outer circumferential sections of the wheel hub 10 and the constant velocity joint 40. A first end face 52 of the sealing ring 50 is supported against an end wall 12 of the wheel hub 10, specifically the inner bearing ring 29 of the right rolling bearing 23, while an opposite second end face 53 rests against a wall step 42 of the constant velocity joint 40. The sealing function related to the face serration assembly 11/41 can be performed at the end faces 52, 53 and/or concerning the outer circumferential sections of the wheel hub 10 and the constant velocity joint 40. If sealing is performed against the outer circumferential sections of the wheel hub 10 and the constant velocity joint 40, it may be possible to dispense with axial support of the end faces 52 and/or 53.

A circumferential web 54 projects radially from the sleeve-shaped first sealing section 51. This web 54 forms a narrow gap with the corresponding wall sections at the wheel carrier 30, which prevents the ingress of water and dirt, thus acting as a pre-seal for the wheel bearing 20 or its seal 25.

In particular, a radially inwardly directed protrusion 31 can be formed at the wheel carrier 30, which features an axial ring wall 32 parallel to the web 54. In the longitudinal cut profile of the sealing ring 50 according to FIG. 1, this results in a gap path extending radially to the axis of rotation A of the wheel hub 10, whose extension is significantly greater than the axial gap path on the outside of the seal between the radial outer edge 55 of the web 54 and the wheel carrier 30.

An additional axial gap on the inside of the seal can be provided between a radial inner edge 33 of the protrusion 31 and the sleeve-shaped first sealing section 51 or a step 56 optionally provided on the latter, as shown in FIG. 1.

Since the protrusion 31 is located at the wheel carrier 30, it can be designed relatively freely. In particular, it is possible to form the protrusion 31 integrally with the wheel carrier 30. However, it is also possible to attach a corresponding ring for the protrusion 31 to the wheel carrier 30 to create more complex sealing gap configurations or labyrinths, if necessary.

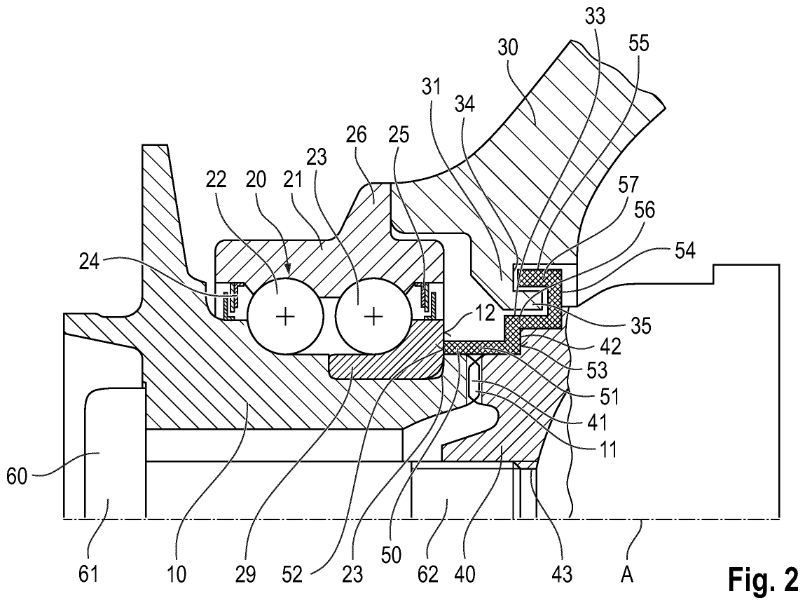

An alternative labyrinth shape for the sealing gap of the pre-seal is shown by way of example in FIG. 2. In this case, in addition to the sleeve-shaped first sealing section 51 for radially sealing the face serration assembly 11/41, the sealing ring 50 includes a sleeve-shaped second sealing section 57 for providing the pre-seal, wherein the sleeve-shaped second sealing section 57 is connected to the first sealing section 52 by a radial web 54.

The sleeve-shaped first sealing section 51 can be designed with or without a step 56, as shown in FIG. 1.

In particular, the sleeve-shaped first sealing section 51, the sleeve-shaped second sealing section 57, and the web 54 can form an approximately C-shaped longitudinal cutting profile in a longitudinal cutting plane, so that an annular groove 58 is formed at the sealing ring 50 around the axis of rotation A, in which a corresponding longitudinal cutting profile on the wheel carrier 30 engages. As is shown in particular in FIG. 2, between the sleeve-shaped first sealing section 51, the sleeve-shaped second sealing section 57, and the web 54 on the one hand, and the corresponding longitudinal cutting profile on the wheel carrier 30 on the other hand, a gap is formed, acting as a complex sealing labyrinth, which provides a high level of protection against the ingress of water and dirt as part of a pre-seal.

The corresponding longitudinal cutting profile at the wheel carrier 30 can, in turn, have at least one annular groove 34, for example on the aforementioned protrusion 31. The annular grooves 58 and 34 at the sealing ring 50 and at the wheel carrier 30 can be interlocked with one another so as to achieve the longest possible gap path on the pre-seal within a compact space. In FIG. 2, the sleeve-shaped second sealing section 57 extends axially into the annular groove 34 on the wheel carrier 30. Similarly, the inner edge 35 of the annular groove 34 extends axially into the annular groove 58 on the sealing ring 50. This principle can be expanded by providing several annular grooves in series.

In the exemplary embodiments shown, the radial web 54 can preferably adjoin an axial end section of the sleeve-shaped first sealing section 51, preferably on the side of the constant velocity joint.

Preferably, the sleeve-shaped first and second sealing sections 51, 57 extend axially in the same direction from the web 54.

The sleeve-shaped second sealing section 57 and the web 54, and optionally also the sleeve-shaped first sealing section 51, together with the protrusion 31 located on the wheel carrier 30, form a sealing labyrinth, the course of which from the outside to the inside of the pre-seal in a longitudinal cutting plane has at least two changes of direction, in particular three or even four changes of direction, so as to significantly inhibit the ingress of water and dirt.

In a modification of the exemplary embodiments of FIGS. 1 and 2, the sealing ring 50 can also be installed in a manner that is rotated axially by 180°. In FIG. 2, the annular groove 58 then does not open toward the constant velocity joint 40, but toward the wheel hub 10.

Furthermore, instead of pre-assembling the sealing ring 50 on the constant velocity joint 40, it is also possible to pre-assemble the sealing ring 50 on the wheel hub 10 first, so that it then becomes engaged with the constant velocity joint 40 when the wheel bearing assembly is assembled.

Another wheel bearing assembly according to the invention comprises at least the wheel hub 10, a wheel bearing 20 arranged at the wheel hub 10, a wheel carrier 30 to which the wheel bearing 20 is fixed with a wheel bearing outer ring 21, the constant velocity joint 40, which is axially clamped to the wheel hub 10 by way of a face serration assembly 11/41, and the sealing ring 50, which radially surrounds the face serration assembly 11/41 on the outside and seals it. This further wheel bearing assembly is refined in that the sealing ring 50, analogous to FIG. 2, comprises both a sleeve-shaped first sealing section 51 for radially sealing the face serration assembly 11/41 and a sleeve-shaped second sealing section 57 for providing a non-contact pre-seal for the wheel bearing 20, wherein the sleeve-shaped second sealing section 57 is connected to the first sealing section 51 by a radial web 54. In addition, the wheel carrier 30 has an annular groove 34, wherein a gap is formed as a sealing labyrinth between the sleeve-shaped first sealing section 51, the sleeve-shaped second sealing section 57, and the web 54 on one side, and the annular groove 34 on the wheel carrier 30 on the other side. Due to the long gap path through the sealing labyrinth, particularly good effectiveness of the pre-seal is achieved.

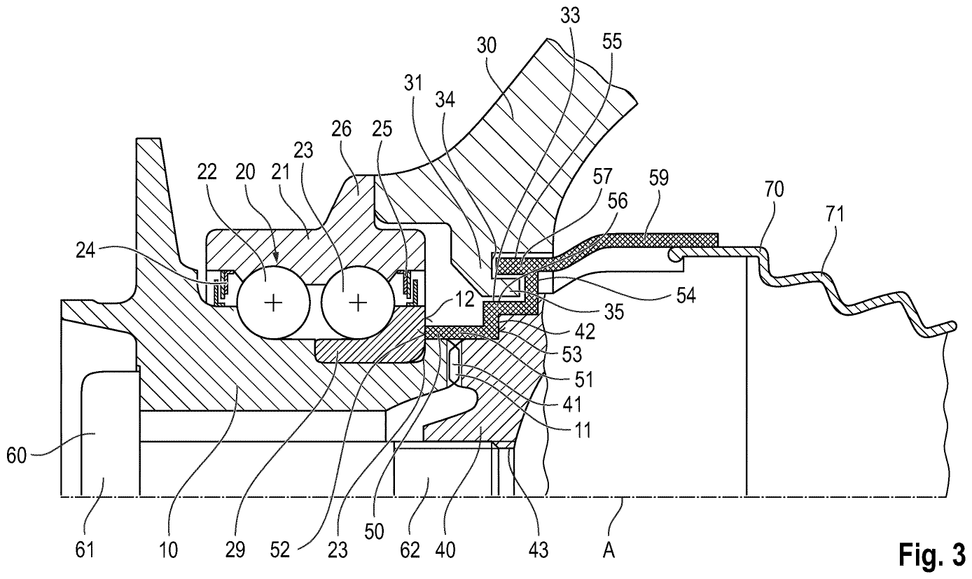

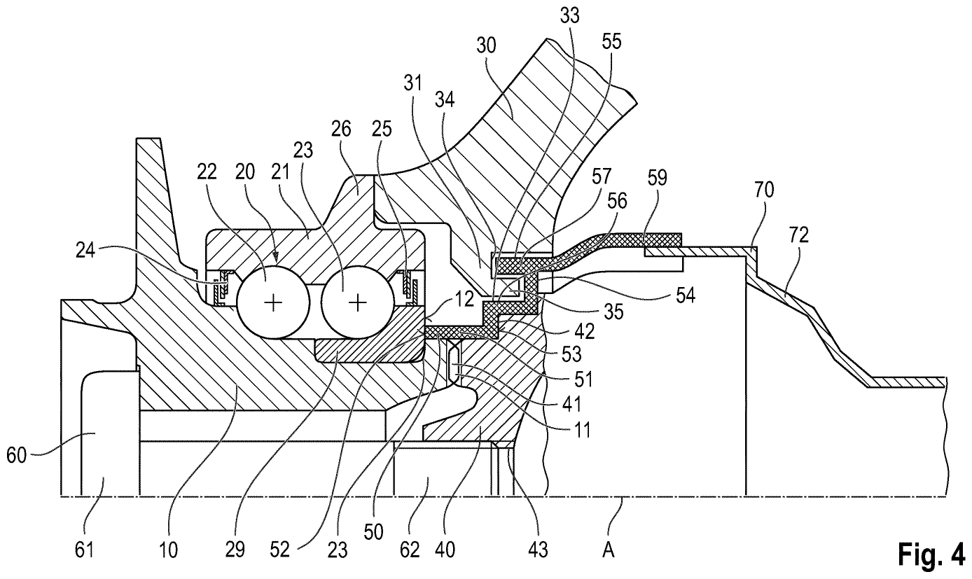

The exemplary embodiments described above can be modified with regard to the sealing ring 50 in that a sleeve-shaped third sealing section 59 is additionally provided at the sealing ring 50, which projects axially from the second sealing section 57 toward the constant velocity joint 40 and rests sealingly against a sealing element 70 of the constant velocity joint 40, as shown in FIGS. 3 and 4 by way of example.

The sealing element 70 of the constant velocity joint 40 can, for example, be a bellows 71, a rolling lobe bellows, a sheet metal cap 72 with a bellows, or the like. It serves to seal the constant velocity joint 40 on the opening side thereof so that no grease can escape or dirt can enter the constant velocity joint 40. Sheet metal caps 72 are generally pressed onto the outer circumference of the constant velocity joint 40 and be crimped. Bellows 71 and rolling lobe bellows can, for example, be fastened to the outer circumference of the constant velocity joint 40 by hose clamps, clamps, or the like.

As a result of the contact between the sleeve-shaped third sealing section 59 of the sealing ring 50 and the sealing element 70 of the constant velocity joint 40, the constant velocity joint 40 is completely covered to the outside, so that painting the outer surfaces of the constant velocity joint 40 to ensure a rust-free appearance can be dispensed with. The sealing ring 50 effectively closes the gap between the sealing element 70 of the constant velocity joint 40 and the wheel hub 10 in the manner of a cover.

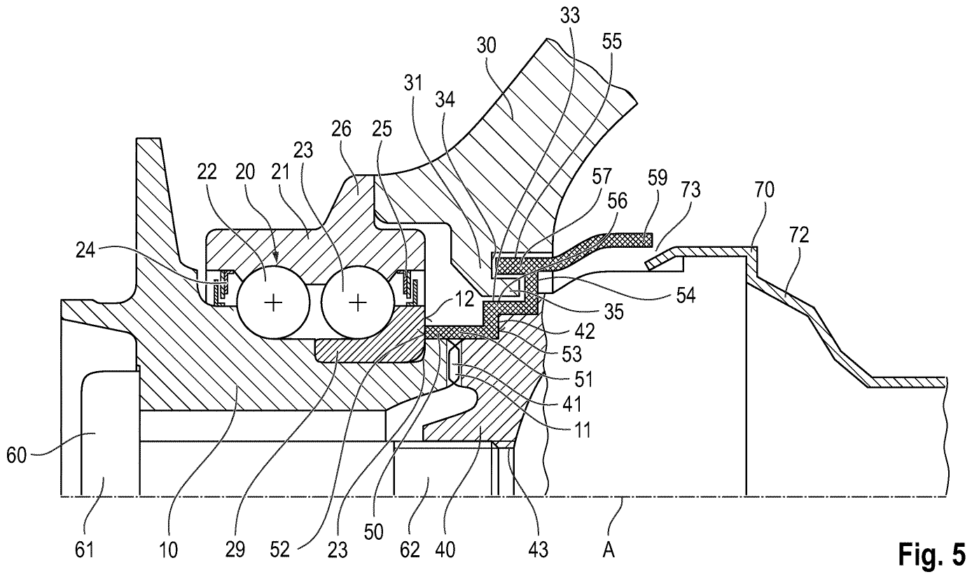

In a further exemplary embodiment according to FIG. 5, a small annular gap 73 can also be deliberately provided between the sealing ring 50 and the sealing element 70 of the constant velocity joint 40, allowing any water that enters to escape quickly. The centrifugal force generated when the drive shaft is rotating can be utilized in this process. As shown in FIG. 5, the sealing ring 50 includes a sleeve-shaped third sealing section 59 that projects axially from the second sealing section 57 toward the constant velocity joint 40, forming the annular gap 73 with the sealing element 70 of the constant velocity joint 40, enabling the removal of any entering water through centrifugal force. The annular gap 73 preferably has a width of 1 to 3 mm.

The third sealing section 59 in FIGS. 3, 4, and 5 can also be designed to extend radially further outward than the maximum radial extension of an annular groove 34 for engagement with the sleeve-shaped second sealing section 57, further impeding the ingress of water and dirt via the pre-seal.

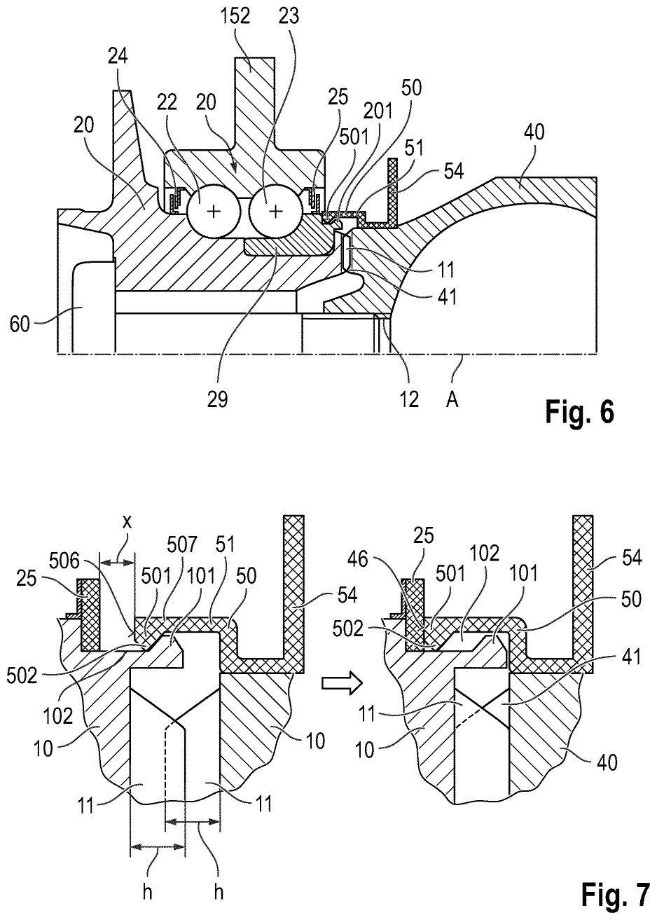

Furthermore, as will be described hereafter based on FIGS. 6 to 11, the sealing ring 50 can additionally serve as a mounting aid when assembling the wheel bearing assembly. It is crucial to ensure that the corresponding face serrations 11 and 41 mesh correctly during the assembly of a face serration assembly to prevent tooth-on-tooth engagement. Such a mounting aid function can also be incorporated in the previously described exemplary embodiments.

The sixth exemplary embodiment in FIG. 6 shows an axially clamped face serration assembly in its final assembly position.

This assembly comprises the first face serration 11 on the wheel hub 10. In the present example, a face serration shall be understood as an end-face radial serration structure on a component which can be coupled with a corresponding end-face radial serration structure on a further component for the purpose of transmitting torque. The axially clamped face serration assembly furthermore comprises the second face serration 41 at the cardan shaft 40. The first face serration 11 and the second face serration 41 are in toothing engagement with one another. This toothing engagement has zero backlash in FIG. 6 and is suitable for transmitting high torque.

Furthermore, the axially clamped face serration assembly comprises the clamping device 60, preferably in the form of a clamping bolt, by way of which, in the clamped state thereof, the first face serration 11 and the second face serration 41 are axially clamped to one another. The clamping device 60 preferably extends centrally through the two face serrations 11 and 41. In particular, the clamping device 60, or the clamping bolt, can be supported on the wheel hub 20 and be bolted to the constant velocity joint 40. A reverse installation is likewise possible.

The sealing ring 50 surrounds the first face serration 11 and the second face serration 41 radially on the outside and seals the same. The sealing ring 50 holds the first face serration 11 and the second face serration 41 loosely in engagement with one another in a manner that will be described in more detail hereafter. This loosely engaged state is also regarded as the pre-assembly position in the present example, in which the wheel hub 10 and the constant velocity joint 40 are already roughly aligned with respect to one another and secured by the sealing ring 50 to prevent these from coming part.

As indicated on the left in FIG. 7, in the pre-assembly position, the axial play x between the two face serrations 11 and 41 is smaller than the height h of the teeth of the first face serration 11 and the second face serration 41. Once the pre-assembly position has been reached, it can thus be assumed that a tooth-on-tooth position of the teeth of the first face serration 11 and the second face serration 41 is precluded.

In a second step, after the pre-assembly position has been established, the clamping device 60 can be activated to achieve zero-backlash engagement between the first face serration 11 and the second face serration 41, thus reaching the final assembly position shown on the right in FIG. 7 and in FIG. 6.

In the final assembly position, the sealing ring 50 effectively prevents moisture and dirt from penetrating into the joint between the first face serration 11 and the second face serration 41, thereby protecting the toothing engagement from corrosion.

The arrangement of the sealing ring 50 in relation to the wheel hub 10 and the constant velocity joint 40, as well as its design, can be implemented in various ways, as will be described in more detail hereafter. It should be noted that the arrangement of the sealing ring 50 and any engagement structures in relation to the constant velocity joint 40 as the first component and the wheel hub 10 as the second component can, in principle, also be reversed.

In one embodiment, as shown by way of example in FIGS. 6 to 8, the sealing ring 50 can be fixed to one of the first and second components, while it is coupled to the other component via a detent mechanism 501. Based on the latching engagement, it can be reliably confirmed that the pre-assembly position has been reached, meaning that a tooth-on-tooth position is precluded.

The sealing ring 50 can be fixed to one of the first and second components, in the present case the constant velocity joint 40 as the first component by way of example, by pressing, gluing, or in any other manner. Preferably, this has already been carried out before the two components, namely the wheel hub 10 and the constant velocity joint 40, are joined to achieve the pre-assembly position.

For the detent mechanism 501, catch lugs 502 can be formed on the sealing ring 50, which are distributed around the circumference thereof and which, after overcoming a protrusion 101 on the other component, in the present case the second component or the wheel hub 10 by way of example, engage in one or more recesses 102 on the other or second component.

A cross-sectional view of such a sealing ring 50 is shown in FIG. 9. In the present example, this sealing ring 50 has three catch lugs 502 on the inner circumferential surface 503 thereof. However, the number of catch lugs 502 can also be smaller or larger than what is shown. The number preferably ranges between approximately 3 and 20.

Accordingly, the corresponding protrusion 101 and the corresponding recess 102 are located on an outer circumferential section of the second component. The protrusion 101 and the recess 102 can be designed as continuous circumferential structures, so that the angular position of the sealing ring 50 in the circumferential direction is irrelevant during assembly. However, it is also possible to provide the protrusion 101 in the form of multiple individual protrusions and/or to provide the recess 102 in the form of multiple individual recesses.

In a modification of the embodiments shown, however, the catch lugs 502 can be arranged on an outer circumferential surface 504 of the sealing ring 50 instead of on the inner circumferential surface 503. Accordingly, the protrusion 101 and the recess 102 of the second component are then located on an inner circumferential section of the same.

As was already mentioned, the catch lugs 102 are accommodated with axial play in the corresponding recess or recesses 102 in the unclamped state of the clamping device 60. When the protrusion 101 is overcome by the catch lugs 502, the overlap of the teeth of the first face serration 11 and of the second face serration 41 is preferably 30% to 90% of the tooth height of the same.

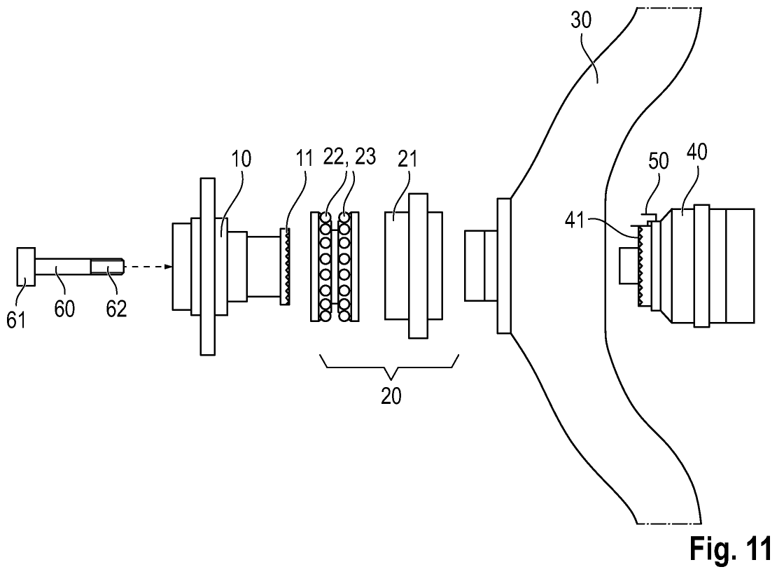

Instead of using catch lugs 502, the pre-assembly position, similar to the left of FIG. 7, can also be pre-fixed with a sealing ring 50 that is slotted in this sub-region. FIG. 10 shows another variant embodiment of the sealing ring 50, which is slotted at several points around its circumference. This design makes it easier to clamp it to either the outer or inner circumferential section of the second component. The slits 505 are positioned to ensure that the sealing action is maintained by the sealing ring 50. The number of slits 505 shown in FIG. 10 is four; however, similar to the catch lugs 502, this number can also be adjusted to be smaller or larger. The coordination for both the catch lugs 502 and the slits 505 is arranged so that the connection can reliably support the weight of the components 10 and 40 being joined, as well as the forces that act when the clamping device 60 is applied.

To facilitate assembly, particularly when using a detent mechanism 501 with catch lugs 502, the sealing ring 50 can include a section 504 on which these catch lugs 502 are formed. This section can be radially elastically compressed and extended to more easily overcome the detent resistance created by the protrusion 101.

Chamfers formed on the catch lugs 502 and/or the protrusion 102 can also provide supportive effects in this regard.

Additionally, the sealing ring 50 can feature a circumferential sealing surface 506 that, in the clamped state of the clamping device 60, is pressed against a corresponding sealing surface 13 on the other component, specifically the second component or the wheel hub 10, by way of example.

The sealing surface 506 on the sealing ring 50 can be formed by an end-face wall section thereof, as is shown in FIGS. 6 and 7.

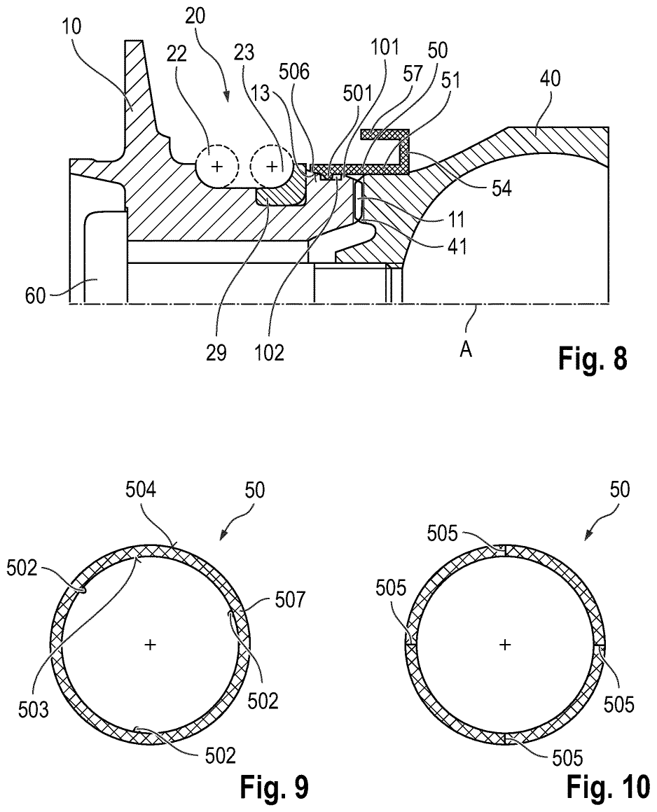

In particular, as is shown within the scope of the further exemplary embodiment according to FIG. 8, the circumferential sealing surface 506 on the sealing ring 50 and the corresponding sealing surface 13 on the other component can have a conical design.

Corresponding conical sealing surfaces 506 and 13 can, of course, also be provided in the further exemplary embodiments and furthermore in variant embodiments that are not shown. For example, the chamfer of the protrusion 101 in FIGS. 6 and 7 can serve as a bearing surface for a corresponding oblique sealing surface that is additionally provided on the ring side.

The sealing ring 50 can be made entirely of plastic material. Sensitive sealing lips can thus be avoided.

The sealing ring 50 of FIGS. 6 to 10 described above also serves as a mounting aid for positioning the components 10 and 40 to be joined, preventing a tooth-to-tooth position. The joining process, until the pre-assembly position is reached, can be carried out in a first step or work cycle. When the clamping device 60 is later applied and clamped in a second step or work cycle, no additional holding device for the respective second component is needed in the current variant embodiments. The axial force applied during clamping is approximately 80 kN or more.

In one variant embodiment, the holding force of the sealing ring 50, which acts as a mounting aid, can be designed so that axial displacement to an end position occurs using the clamping force of the clamping device 60.

As mentioned above, the axially clamped face serration assembly can be used to connect the constant velocity joint 40 to the wheel hub 10, including the wheel bearing 20, as illustrated in an exploded view in FIG. 11. The first component is the constant velocity joint 40, and the second component is the wheel hub 10 with the wheel bearing 20, with the sealing ring 50 fixed to the first component and attached to the second component via the catch lugs 502 or in the region of the slits 505. However, it is also possible to install the sealing ring 50 in the opposite orientation, fixing it to the second component or the wheel hub 10 with the wheel bearing 20, and connecting the region with the catch lugs 502 or slits 505 to the first component or constant velocity joint 40. Corresponding recesses and protrusions must then be provided similarly on the first component or the constant velocity joint 40.

Similarly to FIG. 11, the clamping device 60 can be formed by a clamping bolt, which is centrally passed through the first face serration 41 at the constant velocity joint 40 and the second face serration 11 at the wheel hub 10 so as to axially clamp the relevant components together.

Furthermore, a head 61 of the clamping bolt 60 can be supported on the wheel hub 10, while a threaded section 62 of the clamping bolt 60 is screwed into a threaded opening 43 at the constant velocity joint 40, preferably an axle journal thereof.

The sealing ring 50, intended as a mounting aid, a sealing means, and a wheel bearing pre-seal, is fixed to an outer circumferential section of the constant velocity joint 40. As shown in FIGS. 6 to 8, this sealing ring 50 is coupled to corresponding mating structures at the wheel hub 10 and/or the wheel bearing 20, specifically to a bearing inner ring 29.

FIG. 6 illustrates a variant in which the protrusion 101 and the recess 102 are formed on the bearing inner ring 29 of the wheel bearing 20. The sealing ring 50 can be latchingly engaged with and provide sealing with respect to the bearing inner ring 29.

In FIG. 6, a sealing surface of the sealing ring 50 is supported against a wall section of the bearing inner ring 29. The sealing surface can be pressed against this wall section during assembly to enhance the sealing action.

As a modification, as shown in FIG. 7, in the clamped state of the clamping bolt 60, the sealing ring 50 can be pushed axially against and provide sealing with respect to a section of the wheel bearing seal 25 of the wheel bearing 20. In this case, the section of the wheel bearing seal 25 against which the sealing ring 50 is supported is fixedly arranged on the bearing inner ring 29 of the wheel bearing 20, and if necessary also on the wheel hub 10, to prevent relative movement between the section of the wheel bearing seal 25 and the sealing ring 50 during operation.

Furthermore, as shown in FIG. 8, it is possible to form mating structures for coupling the sealing ring 50 directly to the wheel hub 10, regardless of the presence of the bearing inner ring 29 of the wheel bearing 20. In the variant embodiment according to FIG. 6, a protrusion 101, a recess 102, and a sealing surface 13 are integrally formed directly on the second component, which constitutes the wheel hub 10.

Finally, a possible method for joining a wheel bearing assembly of the type described above will be briefly outlined.

During assembly, the sealing ring 50 can first be fixed to the first component or the constant velocity joint 40. The first component 10 or the constant velocity joint 40 is then provided for the joining process in a state where the sealing ring 50 has already been attached.

Furthermore, the wheel bearing 20 is mounted to the wheel hub 10, and the wheel bearing 20 is subsequently connected to the wheel carrier 30.

In a further step of the joining process, the constant velocity joint 40 and the wheel hub 10, including the wheel bearing 20, are loosely assembled using the sealing ring 50. During this process, the first face serration 11 and the second face serration 41 become partially engaged so that their teeth overlap, while a backlash-free position has not yet been reached. In this pre-assembly position, the wheel hub 10 is fixed in relation to the constant velocity joint 40, ensuring that the two components cannot be easily detached from one another, while also preventing the face serrations 11 and 41 from being in a tooth-on-tooth position. This process step is straightforward to implement.

In a subsequent step, the first face serration 11 and the second face serration 41 are clamped together using the clamping bolt 60. Since the wheel hub 10 has previously been pre-fixed in relation to the constant velocity joint 40, no additional holding device is needed when attaching and tightening the clamping bolt 60. As a result of the tightening, the first face serration 11 and the second face serration 41 bear against one another without backlash. The corresponding clamping is determined based on the torque to be transmitted. This process step is also straightforward to implement. When the assembly position is reached, the sealing ring 50 seals the engagement of the first face serration 11 with the second face serration 41 radially outward, meaning it is no longer a mounting aid but a sealing device. At the same time, the sealing ring 50 engages with the wheel carrier 30 to provide the pre-seal for the wheel bearing 20.

Optionally, the encapsulation of the constant velocity joint described in connection with FIGS. 3 and 4 can also be implemented, and, if necessary, a systematic water drain can be provided in accordance with FIG. 5.

The axially clamped face serration assembly can be disassembled, and in particular, non-destructively disassembled. This is advantageous in the event that a service call is required.

For this purpose, the detent mechanism 501 can be designed in such a way that the catch lugs 502 can be detached using high axial force or a bending moment. For this purpose, accordingly adapted contact slopes or chamfers can be provided.

Likewise, the clamping force when using slots 505 for clamping can be adjusted so that detachment is possible by overcoming the clamping force.

A method for disassembly, for example in the event that a service call is required, can take place in a simple manner as follows. The clamping device 60 is first loosened slightly, preferably in such a way that a partial engagement of the face serrations 11 and 41 is preserved. A clamping bolt can be loosened for this purpose by approximately 3 to 9 mm (corresponding to 2 to 6 revolutions at a pitch of 1.5 mm). Using a soft face hammer, the head 61 of the clamping bolt is struck until the sealing ring 50 detaches in the region of the detent mechanism 501 or of the slits 505. The constant velocity joint 40 can be prevented from falling by the clamping bolt not being loosened completely. After the sealing ring 40 has been detached, the clamping device 60 or the clamping bolt can be unscrewed entirely.

It should be understood the examples described in greater detail above are based on exemplary embodiments and further modifications. In particular, individual technical features that were described above in the context of further individual features can be implemented independently of these as well as in combination with further individual features, even if this has not been expressly described, as long as this is technically feasible. The present disclosure is therefore not expressly limited to the described exemplary embodiments and modifications, but encompasses all configurations defined by the claims.

List of Reference Signs

| | | | |
|---|---|---|---|
| 10 | wheel hub | 26 | supporting and attachment |
| | | | structure |
| 11 | first face serration | 29 | bearing inner ring |
| 12 | end wall | 201 | protrusion |
| 13 | sealing surface | 202 | recess |
| 20 | wheel bearing | 30 | wheel carrier |
| 21 | wheel bearing outer ring | 31 | protrusion |
| 22 | rolling bearing | 32 | axial ring wall |
| 23 | rolling bearing | 33 | inner edge of the protrusion |
| 24 | wheel bearing seal | 34 | annular groove of the |
| | | | protrusion |
| 25 | wheel bearing seal | 35 | inner edge of the annular |
| | | | groove |
| 40 | constant velocity joint | 62 | thread/threaded section |
| 41 | second face serration | 70 | sealing element of the |
| 42 | wall step | | constant velocity joint |
| 43 | thread opening | 71 | bellows |
| 50 | sealing ring | 72 | sheet metal cap |
| 51 | sleeve-shaped first sealing | 101 | protrusion |
| | section | | |
| 52 | end face | 102 | recess |
| | | 501 | detent mechanism |
| 53 | end face | 502 | catch lug |
| 54 | web | 503 | inner circumferential |
| | | | surface |
| 55 | outer edge | 504 | outer circumferential |
| | | | surface |
| 56 | step | 505 | slit |
| 57 | sleeve-shaped second sealing | 506 | sealing surface |
| | section | 507 | section |
| 58 | annular groove on the sealing | | |
| | ring | | |
| 59 | sleeve-shaped third sealing | h | tooth height |
| | section | | |
| 60 | clamping device | x | axial play |
| 61 | head | | |
| A | axis | | |

1-15. (canceled)

16. A wheel-bearing assembly comprising:
a wheel hub;
a wheel bearing arranged at the wheel hub;
a wheel carrier to which the wheel bearing is fixed by a wheel-bearing outer ring;
a constant-velocity joint axially clamped to the wheel hub by way of a face-serration assembly; and
a sealing ring that radially surrounds and seals the face-serration assembly,
wherein the sealing ring is pre-assembled on the constant-velocity joint and, in an assembled state of the wheel-bearing assembly, engages the wheel hub outside a power flow of the wheel bearing, the sealing ring simultaneously providing a non-contact pre-seal for the wheel bearing in cooperation with the wheel carrier.

17. The wheel-bearing assembly of claim 16, wherein the sealing ring comprises a sleeve-shaped first sealing section configured to radially seal the face-serration assembly and a sleeve-shaped second sealing section configured to provide the pre-seal, the sleeve-shaped second sealing section being connected to the first sealing section by a radial web.

18. The wheel-bearing assembly of claim 17, wherein the radial web adjoins an axial end section of the sleeve-shaped first sealing section.

19. The wheel-bearing assembly of claim 18, wherein the sleeve-shaped second sealing section and the radial web, together with a protrusion located on the wheel carrier, form a sealing labyrinth having, in a longitudinal-section plane, at least two changes of direction between an outer side and an inner side of the pre-seal.

20. The wheel-bearing assembly of claim 19, wherein the sleeve-shaped first sealing section, the sleeve-shaped second sealing section, and the radial web define a generally C-shaped longitudinal-section profile forming an annular groove that receives a corresponding longitudinal-section profile of the wheel carrier such that a gap acting as a sealing labyrinth is defined between the sleeve-shaped first sealing section, the sleeve-shaped second sealing section, and the radial web on one side and the corresponding longitudinal-section profile of the wheel carrier on the other side.

21. The wheel-bearing assembly of claim 20, wherein the corresponding longitudinal-section profile of the wheel carrier includes at least one annular groove.

22. The wheel-bearing assembly of claim 16, wherein the sealing ring includes an end face that, in the assembled state of the wheel-bearing assembly, is pressed against an opposing end wall of the wheel hub.

23. The wheel-bearing assembly of claim 16, wherein the sealing ring is formed of a polymeric material.

24. The wheel-bearing assembly of claim 16, wherein the non-contact pre-seal reduces frictional losses of the wheel bearing relative to a conventional contacting seal.

25. A wheel-bearing assembly comprising:
a wheel hub;
a wheel bearing arranged at the wheel hub;
a wheel carrier to which the wheel bearing is fixed by a wheel-bearing outer ring and having an annular groove;
a constant-velocity joint axially clamped to the wheel hub by way of a face-serration assembly; and
a sealing ring that radially surrounds and seals the face-serration assembly,
wherein the sealing ring comprises a sleeve-shaped first sealing section configured to radially seal the face-serration assembly, a sleeve-shaped second sealing section configured to provide a non-contact pre-seal for the wheel bearing, and a radial web connecting the first and second sealing sections,
wherein a gap acting as a sealing labyrinth is formed between the sleeve-shaped first sealing section, the sleeve-shaped second sealing section, and the radial web on one side and the annular groove of the wheel carrier on the other side.

26. The wheel-bearing assembly of claim 25, wherein the sealing ring further comprises a sleeve-shaped third sealing section projecting axially from the second sealing section toward the constant-velocity joint and sealingly engaging a sealing element of the constant-velocity joint.

27. The wheel-bearing assembly of claim 25, wherein the sealing ring further comprises a sleeve-shaped third sealing section projecting axially from the second sealing section toward the constant-velocity joint and defining an annular gap with a sealing element of the constant-velocity joint such that water entering the gap is discharged by centrifugal force.

28. The wheel-bearing assembly of claim 27, wherein the annular gap has a width of about 1 mm to 3 mm.

29. The wheel-bearing assembly of claim 26, wherein the sealing element of the constant-velocity joint comprises at least one of a bellows, a rolling-lobe bellows, or a sheet-metal cap.

30. The wheel-bearing assembly of claim 26, wherein the third sealing section extends radially outward beyond a radial outermost portion of the annular groove of the wheel carrier.

31. The wheel-bearing assembly of claim 25, wherein the sealing ring is manufactured as a single molded component.

32. A wheel-bearing assembly comprising:
a wheel hub;
a wheel bearing arranged at the wheel hub;
a wheel carrier to which the wheel bearing is fixed by a wheel-bearing outer ring;
a constant-velocity joint axially clamped to the wheel hub by way of a face-serration assembly including a first face-serration at the wheel hub and a second face-serration at the constant-velocity joint;
a clamping device configured, in a clamped state, to axially clamp the first and second face-serrations together; and
a sealing ring that radially surrounds and seals the face-serration assembly,
wherein, in an unclamped state of the clamping device, the sealing ring provides an assembly retainer that loosely holds the first and second face-serrations in engagement such that an axial play between the first and second face-serrations is less than a height of the serration teeth.

33. The wheel-bearing assembly of claim 32, wherein the sealing ring is fixed to one of the constant-velocity joint and the wheel hub and is coupled to the other of the constant-velocity joint and the wheel hub by a detent mechanism.

34. The wheel-bearing assembly of claim 32, wherein the sealing ring comprises a sleeve-shaped first sealing section, a sleeve-shaped second sealing section, and a radial web connecting the first and second sealing sections to form a C-shaped longitudinal-section profile.

35. The wheel-bearing assembly of claim 32, wherein the clamping device comprises a threaded fastener configured to apply an axial preload to the face-serration assembly.
